(19) United States
(12) Patent Application Publication
(10) Pub. No.: US 2022/0056974 A1
(43) Pub. Date: Feb. 24, 2022

(54) WET FRICTION MEMBER AND CLUTCH DISK INCLUDING WET FRICTION MEMBER

(71) Applicant: NSK-WARNER K.K., Tokyo (JP)

(72) Inventors: Mutsumi SETOI, Fukuroi-shi (JP); Wenjing LUAN, Fukuroi-shi (JP)

(21) Appl. No.: 17/390,924

(22) Filed: Jul. 31, 2021

(30) Foreign Application Priority Data
Aug. 20, 2020 (JP) 2020-139447

(51) Int. Cl. F16D 69/02; F16D 13/64; F16D 13/72; F16D 13/74

(52) U.S. Cl. CPC F16D 69/026; F16D 13/64; F16D 13/72; F16D 2200/0091; F16D 2200/006; F16D 2200/0056; F16D 13/74

(57) ABSTRACT

Disclosed is a wet friction member for use in a wet clutch that can achieve an increased coefficient of static friction (μs) between it and a counterpart surface in frictional contact with it. The wet friction member includes base paper that is formed using a fiber base material and a filler, and a binder for curing the base paper. The filler includes rubber particles made of at least one kind of highly lipophilic rubber material. The rubber particles contains carbon black for reinforcement.

The disclosure of the following priority application is herein incorporated by reference:

Japanese Patent Application No. 2020-139447.

### TECHNICAL FIELD

The present invention relates to a wet friction member for use in a wet clutch used in an automatic transmission of a vehicle, such as an automobile, and a clutch disk using the wet friction member.

### BACKGROUND ART

Various improvements of wet friction members have been done to increase their friction performance and abrasion resistance.

Patent Literature 1 in the citation list below discloses a wet friction member produced by making base paper by a conventional paper-making process from a base paper material and rubber powder additive mixed therewith, impregnating the base paper with a thermosetting resin, and curing it by heat. The wet friction member disclosed in Patent Literature 1 is not worn much. When used in a clutch, the wet friction member disclosed in Patent Literature 1 can improve the disengagement of the clutch.

Patent Literature 2 in the citation list below discloses a wet friction member produced by impregnating a carbon fiber cloth base with a liquid dispersion of a thermosetting resin, a rubber material, and carbon black and curing it. According to Patent Literature 2, there can be provided a wet friction member that is improved in fitting with a counterpart member in sliding contact with it and provides a high coefficient of dynamic friction.

### CITATION LIST

### Patent Literature

Patent Literature 1: Japanese Patent Application Laid-Open No. H11-210791

Patent Literature 2: Japanese Patent Application Laid-Open No. 2002-179811

### SUMMARY OF INVENTION

### Technical Problem

To improve fuel economy, weight-reduction of vehicles is desired recently. To achieve weight reduction of vehicles, it is necessary to reduce the weights of various components used in vehicles. To reduce the weight of an automatic transmission used in the driving system of a vehicle, it is effective to reduce the number of clutch disks. To enable a reduction in the number of clutch disks, it is effective to increase the coefficient of static friction (μs) of wet friction members used in clutch disks.

The present invention has been made in the above circumstances to provide a wet friction member that can achieve an increased coefficient of static friction (μs) between the wet friction member used in a wet clutch and a counterpart surface that is in frictional contact with it.

### Solution to Problem

To solve the above object, according to the present invention, there is provided a wet friction member comprising:

base paper formed using a fiber base material and a filler; and

a binder for curing the base paper,

wherein the filler includes rubber particles made of at least one kind of highly lipophilic rubber material.

The rubber particles used in the wet friction member according to the present invention may contain carbon black.

The rubber particles used in the wet friction member according to the present invention may contain silica.

The binder used in the wet friction member according to the present invention may include the rubber particles.

### Advantageous Effects of the Invention

The present invention can provide a wet friction member for use in a wet clutch that can achieve an increased coefficient of static friction (μs) between it and a counterpart surface in frictional contact with it.

### BRIEF DESCRIPTION OF DRAWINGS

FIG. 1A is a schematic front view of a clutch disk using a wet friction member according to the embodiment.

FIG. 1B is an enlarged cross sectional view taken online b-b in FIG. 1A, showing a cross section of the wet friction member.

### EMBODIMENT FOR CARRYING OUT THE INVENTION

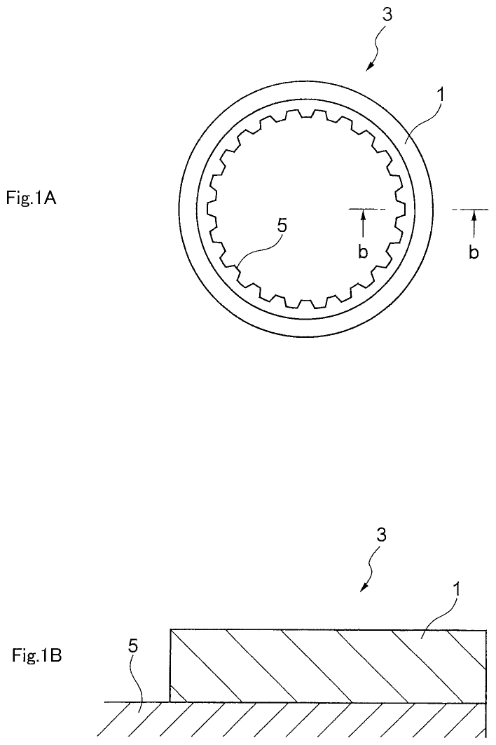

A wet friction member and a clutch disk according to an embodiment of the present invention will be described. FIG. 1A is a schematic front view of a clutch disk using a wet friction member according to the embodiment. FIG. 1B is an enlarged cross sectional view taken on line b-b in FIG. 1A, showing a cross section of the wet friction member.

The wet friction member 1 according to the embodiment is one for use in a wet clutch (not shown) included in an automatic transmission of a vehicle, such as an automobile. The wet friction member 1 and the clutch disk 3 of this embodiment are produced in the following way. The wet friction member 1 is produced by making base paper by a paper-making process from a fiber base material to which a filler and a friction-adjusting agent are added, impregnating the base paper with a binder, such as a thermosetting resin, and curing it. The clutch disk 3 is produced by punching the wet friction member 1 produced in the above way into a designed shape and adhering an annular core plate 5 to it.

As the fiber base material, use may be made, for example, of one or more of fibers containing an inorganic compound, such as glass and silica, fibers containing a metal, and organic fibers, such as aramid fibers.

As the filler and the friction-adjusting agent, use may be made, for example, of one or more of an inorganic compound, such as diatomaceous earth, carbon, and calcium carbonate, and an organic compound, such as a synthetic rubber.

The wet friction member 1 of the present embodiment uses rubber particles as the filler added to the fiber base material. The rubber particles are produced by mixing a raw rubber material, carbon black for reinforcement, and a cross-linking agent, forming a sheet from the mixture, and crushing the sheet. Suitable cross-linking agents may vary depending on the rubber material, and a cross linking agent suitable for the rubber material used is selected. The sheet may be formed by a known method. The rubber material used here includes at least one kind of highly lipophilic rubber. This is because the wet friction member is used in oil, and the rubber material is required to increase the oil-wettability and to enhance the viscoelasticity of the wet friction member. Thanks to the use of the rubber material having high lipophilicity as the filler added to the fiber base material and the addition of carbon black for reinforcement to the rubber particles, the oil-wettability and the viscoelasticity of the wet friction member 1 can be enhanced effectively, and the effect will last over a long time.

As above, the wet friction member 1 according to the embodiment is produced by making base paper by a conventional paper-making process from the fiber base material to which the above-described rubber particles and an inorganic compound, such as diatomaceous earth, are added as fillers, impregnating the base paper with, for example, a thermosetting resin, and curing it. The clutch disk 3 according to the embodiment is produced by punching the wet friction member 1 produced in this way into a designed shape and attaching it to a base core plate 5 as a substrate applied with adhesive together by heat pressing.

The above-described rubber particles made of a rubber material having high lipophilicity may be used as the binder for binding the base paper. This also provides the effect of increasing the wettability and the viscoelasticity of the wet friction member 1. The rubber particles may be used as both the filler added to the fiber base material and the binder for binding the base paper. This also provides the same effect.

To reinforce the rubber particles, silica may be added instead of carbon black.

Thanks to the addition of the rubber particles made of a lipophilic rubber material to the base paper and the addition of carbon black or silica for reinforcement to the rubber particles, the oil-wettability and the viscoelasticity of the wet friction member 1 according to the embodiment produced as above can be enhanced effectively, and the effect will last over a long time. Therefore, the wet friction member 1 has a stable viscoelasticity in oil, and the coefficient of static friction between it and a counterpart surface in frictional contact with it can be increased. The increased coefficient of static friction between the wet friction member 1 and the counterpart surface in frictional contact with it allows a reduction in the number of clutch disks 3 used in a wet clutch.

### EXAMPLES

In the following, examples of the wet friction member according to the embodiment will be described. Moreover, an evaluation test that we conducted on the examples and comparative examples will also be described.

As described above, the wet friction member according to the present embodiment uses rubber particles as the filler added to the fiber base material. The rubber particles are produced by mixing carbon black and a cross-linking agent with a rubber material or mixing silica and a cross-linking agent with a rubber material, forming a sheet from the mixture, and crushing the sheet. As examples, we made two wet friction members using two kinds of rubber material, which are styrene-butadiene rubber (which will be referred to as “SBR” hereinafter) and polyisobutylene rubber. These rubber materials both have high lipophilicity. Use of a rubber material having high lipophilicity as a filler added to the fiber base material and the addition of carbon black or silica for reinforcement can enhance the oil-wettability and the viscoelasticity of the wet friction member effectively, and the effect will last over a long time. While one kind of rubber material is used for one material, a blend of two kinds of rubber materials may be used.

As comparative examples to be compared with the above two rubber materials, we made rubber particles using nitrile rubber (which will be referred to as “NBR” hereinafter) and produced a wet friction member using the nitrile rubber particles as the filler added to the fiber base material. The nitrile rubber is conventionally used as a component of fillers in many cases. SBR and polyisobutylene rubber used in our examples are rubber materials having higher lipophilicity than the nitrile rubber. The lipophilicity is an index indicating the affinity to oil. For example, in the case of rubbers, the lipophilicity indicates the permeability of oil into their structure. The higher the lipophilicity of a rubber is, the more oil permeates the rubber. The lipophilicity of rubber materials can be evaluated by, for example, oil immersion test (according to JIS K6258). It is preferred that the rubber particles have diameters in the range of 1 to 200 μm. If the diameters of rubber particles are smaller than 1 μm, the reinforcing material (e.g. carbon black) cannot exercise its effect. If the diameters of rubber particles are larger than 200 μm, aggregation in the paper-making process becomes unstable, leading to a decrease in the uniformity of the base material.

Table 1 below shows the proportions of the components of three different kinds of rubber particles (or rubber particles 1, rubber particles 2, and rubber particles 3), which are made of SBR, polyisobutylene rubber, and NBR respectively. The proportions in table 1 are in weight percent.

It is preferred that the weight proportion of the rubber component in rubber particles be in the range of 30% to 80%. If the weight proportion of the rubber component is lower than 30%, the rubber component cannot exercise its effect. If the weight proportion of the rubber component is higher than 80%, the reinforcing material (e.g. carbon black) cannot exercise its effect.

TABLE 1

| | | | Cross-linking |
|---|---|---|---|
| | Rubber particles | Carbon black | agent, others |
| | (%) | (%) | (%) |
| Rubber | SBR: 55 | 30 | 15 |
| particles 1 | | | |
| Rubber | polyisobutylene | 30 | 15 |
| particles 2 | rubber: 55 | | |
| Rubber | NBR: 55 | 30 | 15 |
| particles 3 | | | |

Table 2 below shows respective proportions of the components of the base paper for examples of the wet friction member according to the embodiment and comparative examples. The proportions in table 2 are in weight percent.

The base paper of the wet friction member of example 1 was produced by a paper-making process from a fiber base material to which rubber particles 1 and an inorganic compound (e.g. diatomaceous earth) were added as fillers.

The base paper of the wet friction member of example 2 was produced by a paper-making process from a fiber base material to which rubber particles 2 and an inorganic compound (e.g. diatomaceous earth) were added as fillers.

The base paper of the wet friction member of comparative example 1 was produced by a paper-making process from a fiber base material to which rubber particles 3 and an inorganic compound (e.g. diatomaceous earth) were added as fillers.

The base paper of the wet friction member of comparative example 2 was produced by a paper-making process from a fiber base material to which an inorganic compound (e.g. diatomaceous earth) was added as a filler. The base paper of the wet friction member of comparative example 2 does not contain rubber particles.

The preferred range of the proportion of rubber particles in weight in the base paper of the wet friction members is 1% to 60%. If the weight proportion is lower than 1%, the rubber particles cannot exercise its effect. If the weight proportion is higher than 60%, the effect of the rubber component will saturate.

TABLE 2

| | | Filler (e.g. | |
|---|---|---|---|
| | | diatomaceous | |
| | Fiber base | earth and | Filler (rubber |
| | material (%) | others) (%) | particles) (%) |
| Example | 50 | 30 | 20 |
| 1(rubber | | | |
| particles | | | |
| 1) | | | |
| Example | 50 | 30 | 20 |
| 2(rubber | | | |
| particles | | | |
| 2) | | | |
| Comparative | 50 | 30 | 20 |
| Example | | | |
| 1(rubber | | | |
| particles | | | |
| 3) | | | |
| Comparative | 50 | 50 | — |
| Example 2 | | | |

The wet friction members of the examples and the comparative examples were produced by impregnating the base paper specified in Table 2 with a binder (e.g. thermosetting resin) and curing them. Then, each of the wet friction member of the examples and the comparative examples was punched into a designed shape, and a clutch disk was produced by adhering the punched wet friction member to a core plate.

While in the above examples, the rubber particles were added as a component of the base paper, the rubber particles may be used as a component of a binder for the base paper.

We conducted an evaluation test on the examples and the comparative examples of the wet friction member. Details of the evaluation test and its result will be described in the following.

We conducted the evaluation test using the SAM testing apparatus to measure the coefficient of static friction (μs). Table 3 below shows the conditions of the test, and table 4 below shows the result of measurement.

TABLE 3

| | Condition |
|---|---|
| Rotation speed (rpm) | 0.72 |
| Applied pressure (MPa) | 2 |
| Oil temperature (° C.) | 120 |
| Number of disks | 3 |

TABLE 4

| | μs |
|---|---|
| Example 1 | 0.129 |
| Example 2 | 0.133 |
| Comparative example 1 | 0.114 |
| Comparative example 2 | 0.113 |

As shown in table 4, the coefficients of static friction (μs) of examples 1 and 2 were both larger than those of comparative examples 1 and 2. Specifically, the coefficient of static friction of example 1 was 13% larger than that of comparative example 1, and the coefficient of static friction of example 2 was 17% larger than that of comparative example 1. This demonstrates that use of a lipophilic rubber as a filler for the base paper of the wet friction member used in clutch disks of wet clutches leads to an increase in the coefficient of static friction (μs).

As described above, according to the present embodiment, there can be provided a wet friction member that has stable viscoelasticity in its material in oil and can achieve an increase in the coefficient of static friction between it and a counterpart surface in frictional contact with it. There can also be provided a clutch disk using such a wet friction member. Moreover, thanks to an increase in the coefficient of static friction between the wet friction member and a counterpart surface in frictional contact with it, it is possible to reduce the number of clutch disks used in a wet clutch.

### REFERENCE SINGS LIST

1: wet friction member
3: clutch disk
5: core plate

1. A wet friction member comprising:
base paper formed using a fiber base material and a filler; and
a binder for curing the base paper,
wherein the filler includes rubber particles made of at least one kind of highly lipophilic rubber material.

2. A wet friction member according to claim 1, wherein the rubber particles contain carbon black.

3. A wet friction member according to claim 1, wherein the rubber particles contain silica.

4. A wet friction member according to claim 1, wherein the binder comprises the rubber particles.

5. A clutch disk comprising a wet friction member according to claim 1.

6. A wet friction member according to claim 2, wherein the binder comprises the rubber particles.

7. A wet friction member according to claim 3, wherein the binder comprises the rubber particles.

8. A clutch disk comprising a wet friction member according to claim 2.

9. A clutch disk comprising a wet friction member according to claim 3.

10. A clutch disk comprising a wet friction member according to claim 4.

11. A clutch disk comprising a wet friction member according to claim 6.

12. A clutch disk comprising a wet friction member according to claim 7.
